(19) United States
(12) Patent Application Publication
(10) Pub. No.: US 2006/0095473 A1
(43) Pub. Date: May 4, 2006

(54) System and method of orchestrating electronic workflow automation processes

(75) Inventor: Gregory K. Fox, Moorestown, NJ (US)

Correspondence Address: Altimatia, L.L.C, 16 Elm Ridge Road, Pennington, NJ, 08534, US

(73) Assignee: Data Management Associates, Inc., Moorestown, NJ (US)

(21) Appl. No.: 11/255,755

(22) Filed: Oct. 22, 2005

Related U.S. Application Data
(60) Provisional application No. 60/621,267, filed on Oct. 23, 2004.

(51) Int. Cl. G06F 17/00

(52) U.S. Cl. 707/104.1

(57) ABSTRACT

In one embodiment, a system for conducting automated and user-assisted electronic workflow is provided, comprising: the means to monitor one or more external processes for input, messages, changes and specific states; the means to transfer information from the process monitors to one or more term recognizers in an application-independent manner; the means to publish the results of term recognizer evaluations; the means to invoke one or more action handlers, whereby an action handler may communicate with one or more data integration components, each being associated with a corresponding application or data store.

### CROSS REFERENCE TO RELATED APPLICATIONS

This application claims the benefit of U.S. Provisional Patent Application Ser. No. 60/621,267.

### FIELD

The present system and method relate to software for automating workflow, including computer-based workflow. More specifically, the present system and method relates to specifying and implementing workflow automation processes.

### BACKGROUND

Information workers require increasingly large amounts of computer-based data in order to perform their tasks. The volume and granularity of stored transaction detail is rising and the complexity of business transactions is increasing. Transaction complexity is increasing due to the increasing number of data sources and data types used to process a given transaction. Automated solutions which compensate for transaction complexity due to rising data volume and data detail are needed. The present invention addresses the bottleneck of user access to relevant information at the point of initiation of human business workflow (HBW).

Because human business workflow often revolves around documents, systems and methods have been developed to automate specific aspects of such workflow. Computer-based Natural Language Processing (NLP) systems have been developed to extract meaning from sources of free-form text. These systems are used in HBW to automate high volumes of document analysis for purposes such as classifying unstructured data. While NLP functionality, alone, does not automate workflow, it is an important tool in solving workflow problems.

Email Response Management Systems (ERMS) have been developed to automate the generation of email responses to email queries from customers. ERMS systems may make use of NLP techniques to identify the content of the incoming email.

Automatic Document Creation (ADC) is a broader category of software which includes template-driven data merges, report-writers, and some ERMS systems. Likewise, Dynamic Query Processing, Data Mapping and Tagging methods are tools used for the automation of data-related HBW.

Workflow specifics vary widely. Many tools are currently used to implement automation solutions. An object of the current system and method is to provide a missing link: an architecture, system and method for orchestrating workflow automation processes. The system and method may optionally comprise the above-mentioned software component categories. Specific benefits and advantages of the workflow automation system and method will be made apparent through the following detailed description with references to accompanying drawings, which specify and illustrate embodiments of the system and method.

Background information related to embodiments of the present system and method may be found in the following U.S. Pat. Nos. 3,339,795, 6,651,058, 6,651,059, 6,138,088, and U.S. Patent Application Publications 2002/0007356, 2002/0038217, 2003/0135488, 2003/0158855, 2003/0188037, 2004/0103014, 2004/0162812, 2004/0167911, 2004/0199867, and 2004/0225671. The above cited patents and patent application publications are hereby incorporated herein by reference.

### SUMMARY

FIG. 1 shows a generalized block diagram of “human business workflow” (HBW) involving a person(1) who must access data in order to process a document. In this description ‘HBW’ will be assumed to include any workflow that involves processing of a document(2) and may also involve the related actions of data access (read or write)(3) and a plurality of responses(4). The document(5) in this example represents the focus of the user's attention and a trigger or cause of the related analysis, data-access and response steps. The data(6) may reside in zero, one, or more data systems, each possibly linked to the others either directly, or indirectly. The responses(7) may include a plurality of steps including but not limited to additional data access procedures, computer screen displays, document creation, manual processes, and replies. In this typical workflow the user must initialize and orchestrate any related data access and response. Manual data retrieval is time consuming and shifts the users' focus away from the document being processed.

Embodiments of the present system and method address these problems by automating workflow steps that are time-consuming, mundane, or voluminous. Shown in FIG. 2 is an illustration of an embodiment of the present system and method, as applied to the HBW associated with a text-7 document.

FIG. 2 shows a generalized block diagram of HBW, implemented according to the present system and method, involving a person(1) who processes a document or series of documents(2) and is aided by an automation processor(3) in the execution of data access(4) and response(5) steps. Embodiments of automation processors of the invention comprise at least one processor monitor component for monitoring at least one external process, at least one term recognizer component which receives data from the at least one process monitor and from zero, one, or more other term recognizers. Term recognizers may retrieve data related to terms from at least one data access (read/write) component communicating with at least one data storage component. Embodiments of the invention further comprise at least one action handler component which receives data from the at least one term recognizer, and optionally at least one event handler component which responds to events and passes messages between components. In addition, embodiments of the invention may optionally comprise at least one user interface component for displaying data to users and receiving input from users. Embodiments of the invention may optionally expose their functionality to external programs through standard application programming (API) interfaces such as COM interfaces, .NET interfaces, XML interfaces, JAVA interfaces and the like. The API interfaces allow external programs to connect to, and control the actions of, systems of the invention. Embodiments of the invention may optionally include system configuration components, allowing users to configure the behavior and actions of the system to suit their particular workflow automation needs.

For example, process monitors of an embodiment of the system may monitor the actions of a user working with a software program such as Microsoft Word, Microsoft Excel, or Microsoft Outlook. As the user is working on a document the process monitors communicate document data to the term recognizers which in turn analyze the document data for terms such as names and addresses, telephone numbers, and electronic mail addresses. When the term recognizers identify likely terms they attempt to retrieve relevant data from one or more data storage systems, such as ACT! by Sage Software. If relevant data are found, then terms present in the users document are highlighted to inform the user of the presence of term-related data. The additional data may be accessed by clicking on a highlighted term or by picking an item from a displayed list. The user may then act on the data as needed.

Another embodiment of the system utilizes process monitors that monitor caller id information from a modem, a call monitoring unit (such as Whozz Calling from CallerID.com), a pbx system, or a Voice Over IP (VOIP) system. When a call is received a process monitor communicates the caller id data to the term recognizers, which in turn retrieve data related to the caller id, such as name, address, personal information, contact history, time of last contact. The data may be retrieved from a pluratlity of data storage systems such as SQL databases or systems such as ACT! from Sage Software or Goldmine from Frontrange Solutions. After retrieving and assembling the data the system presents the caller id term-related data to the user. By automatically retrieving, assembling, and displaying contact data to the user, the system provides valuable information support to sales personnel and other users.

An embodiment of the system may be used to respond to electronic mail messages. For example, if an electronic mail inquiry is received, such as a request for information. Process monitors connected to the electronic mail system will detect the presence of the new message, send the message data to the term recognizers, which will then analyze the message data for key terms, such as ‘please send information’, ‘request information’, ‘send specifications’, and the like. The system may then automatically send an email reply, or place a reply in an outbox for examination by a local user prior to mailing. Term recognizers may also look for data related to the person sending the request, such as name, title, company, address, telephone number, electronic mail address and the like. The system may attempt to determine if the requestor is present in a data storage system, or if the requestor in a new contact. If the requester is an existing contact, a note may be made in a contact history and if the requestor is a new contact then a new record may be created in the data store recording the relevant contact information.

### BRIEF DESCRIPTION OF THE DRAWINGS

FIG. 1 shows a generalized block diagram of “human business workflow” (HBW) involving a person who must access data in order to process a document.

FIG. 2 shows a generalized block diagram of HBW, implemented according to the present system and method.

FIG. 3 shows a high-level diagram of the main flow of a workflow automation processor (WAP) implemented according to the present system and method.

FIG. 4 shows detailed relationships between process monitors and other system recourses.

FIG. 5 shows detailed relationships between term recognizers (TR) and other system resources.

FIG. 6 shows action handlers and their relationship with other system resources.

FIG. 7 shows the data mapping subsystem objects and their relationship to main system resources.

FIG. 8 shows the objects and relationships of the process monitor subsystem

FIG. 9 shows the objects and relationships of the term recognizer subsystem.

FIG. 10 shows the objects and relationships of the action handler subsystem.

FIG. 11 shows a screen view of a WAP configuration window showing Recognizer groups and the user's ability to switch on/off a group of Term Recognizers for a specific application (Microsoft Word and Excel)

FIG. 12 shows a screen view of WAP Recognizer configuration window showing specified TermRecognizers.

FIG. 13 shows a screen view of WAP Data Atlas Field Definition List.

FIG. 14 shows a screen view of WAP Data Map in a Name Term Recognizer Data Atlas, which relates Data Atlas fields to database fields

FIG. 15 shows a screen view of WAP Data Object list in a Name Term Recognizer Data Atlas, which defines related database lists and records.

FIG. 16 shows a screen view of WAP Display Behavior settings in a Name Term Recognizer Data Atlas, which defines the way a contact record is displayed by the WAP.

FIG. 17 shows a screen view of WAP Data Access Connection settings in a Name Term Recognizer Data Map.

FIG. 18 shows a screen view of WAP Action Handler settings in a Name Term Recognizer.

FIG. 19 shows a screen view of WAP Action Item List in an Action Handler Group.

FIG. 20 shows a screen view of WAP Add-In for ACT Control Panel

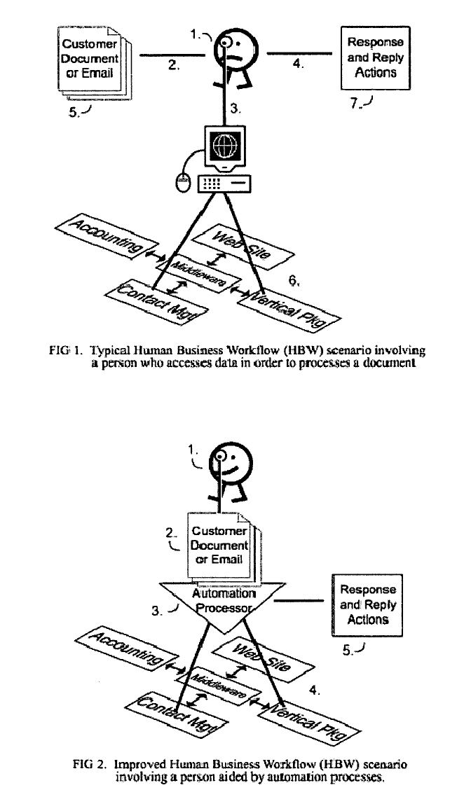

### DETAILED DESCRIPTION

Embodiments of the invention may run on conventional computer systems including personal computers, desktop computers, laptop computers, workstation computers, and server computers. Such systems may execute one or more conventional computer operating systems for example, versions of Microsoft Windows, Linux, Lindows, Unix, and the Macintosh operating system from Apple computer. Embodiments of the invention may be written using conventional programming languages such as C, C++, C#, FORTRAN, PASCAL, Visual Basic, Basic, JAVA, and the like.

The system may be embodied on a computer readable medium. The computer readable medium may comprise a CDROM, a floppy disk, a hard disk drive, random access memory, magnetic tape, paper tape, DVD, CD R/W disk, or any other optical, magnetic, or electronic medium capable of storing digital information.

Embodiments of the system are workflow automation processors comprising at least one process monitor, at least one term recognizer, and at least one action handler. The process monitors monitor external processes and communicate data to term recognizers. Process monitors may be configured to monitor telephone systems, word processing systems, electronic mail systems, spreadsheet systems and other systems. The term recognizers analyze data for terms, retrieve data related to terms from at least one data access component, assemble data related to terms, and communicate data to other system components, such as action handlers. The action handlers receive assembled data from term recognizers and initate at least one action, such as displaying data to a user for a decision, creating an electronic mail message, creating a document, or taking another action. Embodiments of the invention may optionally comprise at least one user interface component configured to display data to users and receive input from users. Embodiments of the invention may optionally comprise at least one event handler component which responds to events and passes messages between components. Embodiments of the invention may optionally comprise system configuration components, allowing users to configure the system to meet their needs. In addition, embodiments of the invention may optionally comprise at least one application programming interface, such as a COM, .NET, XML, or JAVA interface. The programming interface allows the system to be conveniently used by other programs.

Emobdiments of the present system and method address the problem of automating workflow steps that are time-consuming, mundane, or voluminous. FIG. 2 is a first embodiment of the system and method, as applied to the HBW associated with a text-document.

FIG. 2 shows a generalized block diagram of HBW, implemented according to the present system and method, involving a person(l) who processes a document or series of documents(2) and is aided by an automation processor(3) in the execution of data access(4) and response(5) steps. In this diagram the document represents one or more containers of text and also represents raw information that is input to the automation processor. A plurality of raw information sources is possible. The automation processor may respond to the presence of the document itself and/or its contents. A document may be comprised of a plurality of text units, such as sections, paragraphs, sentences, words, cells, tables, and blocks. A document may contain single characters, words, phrases, and other composite textual structures of varying lengths. A document may originate from a plurality of sources, such as a document-based software application, a non document-based software application, a Web page, a voice-to-text application, or an optical character recognition (OCR) system. A document may exist in a plurality of physical forms, including a physical computer file, or a block of random access memory (RAM). The contents of the document may exist in a number of text-document formats such as TXT, RTF, HTML, PDF, XML, Microsoft Word format, Word Perfect format, and others. The contents may also exist in binary formats such as BIN, GIF, TIFF, PICT, JPEG or in a custom or proprietary format. It should be noted that the term “document” is used in its broadest scope, meaning a container of information. Thus, a document could refer to an electronic-paper document, information stored in computer memory, or any other container of information, such as a message from a telephone system containing Caller-ID information.

The workflow automation processor obtains or accepts such documents as input. Obtaining or accepting a document is a possible trigger event which initiates a series of steps leading to workflow automation.

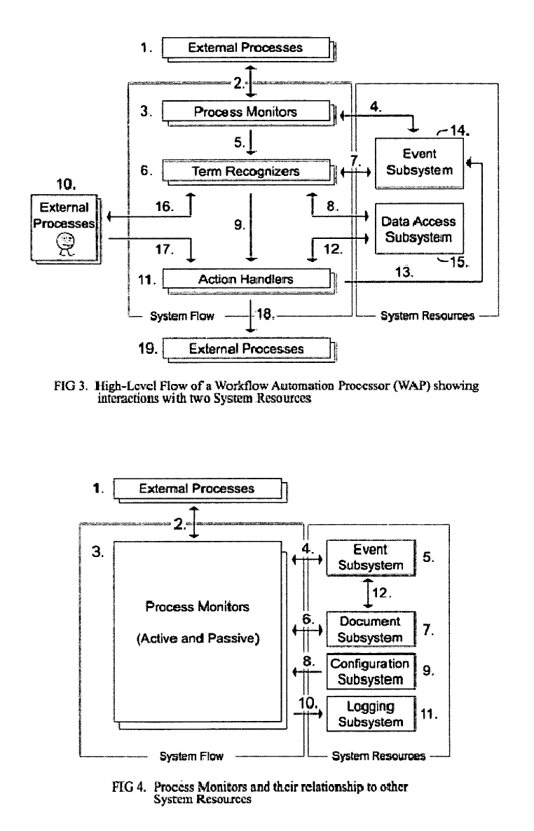

FIG. 3 shows a high-level diagram of the main flow of a workflow automation processor (WAP) implemented according to an embodiment of the present system and method. The WAP system (‘system’) itself resides in its own process on either a personal computer, desktop computer, laptop computer, workstation or on a server. The system comprises a plurality of process monitors(1) which communicate with external processes by responding to events and messages and/or polling the external process for information(2). A process monitor, for example, may respond to incoming emails or may respond to changes in a word-processing document. Likewise, a process monitor may accept a request from an application to evaluate a specified block of information.

Two system resources are shown in FIG. 3: the event subsystem(14) and the data-access subsystem(15). The two subsystems shown are involved in the main system flow. A process monitor may optionally communicate(4) with the event subsystem. The event subsystem manages all workflow-related events for the system with a publish and subscribe mechanism. The main consumers of such events are the term recognizers(6) which respond to published events. (7)

The Workflow Automation Processor (WAP) system described and depicted in FIG. 3 is comprised of multiple subsystems with interrelated functionality. Three main subsystems which handle the process flow are the process monitors, term recognizers, and action handlers. Objects in the these subsystems are implemented as individual classes or functionally related sets of class modules. The WAP system is implemented as a standalone process that can be started manually, or automatically at computer startup, or automatically as needed in response to messages from a process monitor. The WAP process can be installed on personal computer, desktop computer, laptop computer, workstation or server, depending on the physical and logical locations of the processes being monitored and the actions being automated.

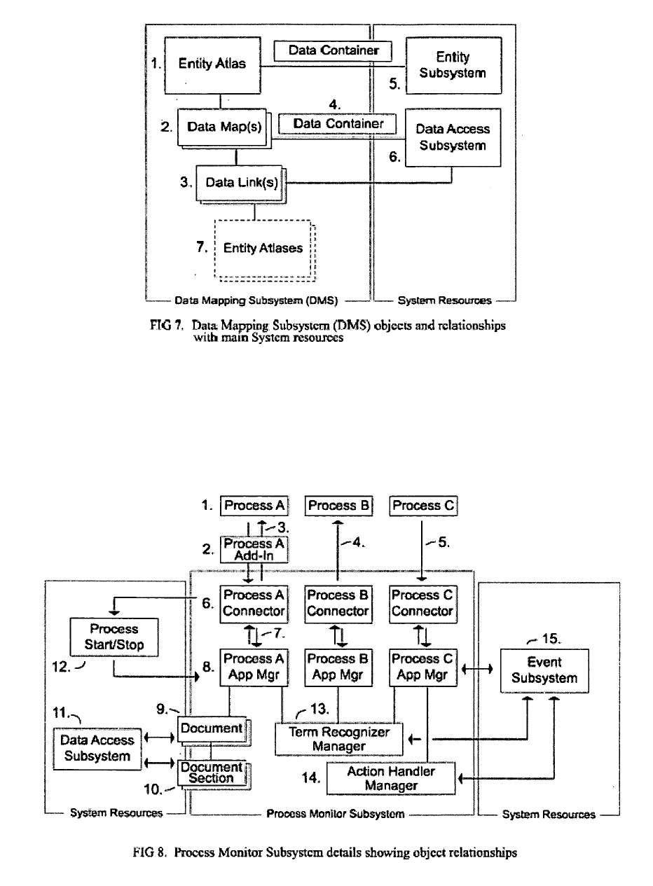

The Process Monitor Subsystem shown in FIG. 8 provides connections between the WAP and individual external processes (1). The WAP manages a plurality of process monitors (3) each of which are specific to an individual external process and which communicate with the external process in a manner specific to the external process. The WAP includes the functionality necessary for a third party to create a process monitor and to instruct the WAP system to instantiate and manage the process monitor. Process monitors may be configured to monitor external word processing systems, telephone systems, electronic mail systems, spreadsheet systems, and other application systems.

FIG. 4 shows detailed relationships between process monitors and other system resourses. The primary role of a Process Monitor (PM)(3) is to serve as an interface between an External Process (EP)(1) and the WAP system. There can be more than one external process for a given workflow and each external process may interface with one or more PM's in the system. The interfaces between a given EP and the system are specific to the EP and the workflow being automated.

Two message categories travel the path(2) between an EP and a PM: discovery (or input) and actions (or output). Each category may involve two-way communication between the EP and the PM. Discovery is the process by which the automation process flow is initiated, when it is initiated from EP-related activity. PM's can be either active or passive. Active PM's and their dependent or contained components are typically instantiated and initialized in response to a trigger message from the EP. Such PM's may have a hook or an add-in to the host EP which is able to respond to startup and shutdown events for that purpose. An active PM will initiate the discovery process by responding to events published by and messages sent by the EP. The information obtained from the EP is usually not a specific request for the initiation of the automation process but rather an indication of a state change in the EP (host application). An active PM initiates the workflow automation process on its own. A benefit of the active mechanism is that it allows the WAP system to initiate a workflow automation process without knowledge or participation by the external process.

A passive PM is one that does not initiate the WAP but responds to such initiation by an EP. A passive PM may be optionally instantiated and initialized in response to a trigger message from an EP. Such PM's may have a hook or an add-in to the host EP which is able to respond to startup and shutdown events. The PM's may be optionally instantiated by a host process with knowledge of the WAP system. A benefit of the passive mechanism is that it allows the WAP system to be utilized by an external process.

A Process Monitor is comprised of two related objects, a Process Connector (PC, 6) and a Process Application Manager (PAM, 8). PC's generally run in the process of the external application; PAM's run in the WAP's process. The relationship of the PC to the external process is specific to the external process. The three most common relationships are depicted in FIG. 8 as Process A, Process B and Process C (1). External Process A represents an application which exposes its functionality through an Add-In mechanism. In this case an Add-In object (2) is created and linked to Process A by the mechanism specified by that process. The Add-In instantiates a corresponding PC. The Add-In functions to pass messages between the Process A and Process Connector A. External Process B represents an application which is monitored by the WAP without the use of an Add-In intermediary. Process Connector B could install itself as an event handler of Process A events or periodically polls Process A for specific information (4). Process B represents the group of applications where the WAP plays a more active role and the External Process plays a more passive role in the communication between the processes. External Process C represents an application which plays an active role in the initiation of communications between the External Process and the WAP. Process Connector C (6) receives messages (5) from External Process C which initiates a WAP workflow sequence. The unidirectional arrows (4, 5) indicate the initiation of messaging; all messaging is assumed to be bidirectional.

Process Connectors function to buffer and filter communications between the WAP and External Processes and to minimize inter-process communications. PC's that communicate with word processing, spreadsheet and email client applications encapsulate the functionality necessary to identify text blocks to be analyzed and to tag them with identifying properties indicating their origin. The information obtained from the External Process, called Discovery, is usually not a specific request for the initiation of the automation process but rather an indication of a state change in the host application. The WAP as a whole operates asynchronously and output from the WAP in the form of search results, context matches, action lists and action initiation generally is not sent to the External Process back through the Process Communicator. The PC functions primarily in communications related to the acquisition of external events such as opened documents, typed words or incoming phone calls.

Process C Connector (6) provides the additional functionality of optionally acquiring and returning any of the said results directly and either synchronously or asynchronously to External Process C, thus providing a single point of communication between External Process C and the WAP. The manner in which the WAP system operates in response to a request from External Process C is configurable and can be specified externally by a configuration file attached to the initiation message (4). Process Connectors may expose public interfaces comprising COM, .NET, JAVA, and XML interfaces for the purpose of enabling the WAP to be utilized as a set of services to external applications.

Process Application Managers (PAM) link individual Process Connectors to the Term Recognizer Subsystem. Additionally they can buffer External Process object references, and document content. Document content is buffered by PAMs which perform a change analysis in order to pass along additional information to the Term Recognizer System. The Microsoft Word application PAM is one such example, as in the case of a document being analyzed as it being created or edited. The PC identifies changes to the text and identifies the position of changed text in the document. This information is communicated to the PAM, which also buffers document contents in a two-level object model containing Document (9) and Document Section (10) objects such as paragraphs and cells. Persistence of these objects is handled by the WAP's Data Access system (11). Storage of the previous document content and positional information provides such PAMs with the ability to compare current content with previous content and identify the specific changes made since the last analysis, to pass such change information to the Term Recognizer system and to buffer change information for Term Recognizers configured to process changes in specific groups such as by paragraph, sentence or cell.

PAMs communicate with PCs (7) through a handshaking mechanism. When the WAP system instructs a specific PAM that it is ready to process its requests, the PAM raises a system event to let its corresponding PC that it is ready to receive instructions. The PC, in turn, sends zero, one or more instructions to the PAM and the PAM then executes those instructions. In addition to operating instructions, the PC also communicates to the WAP that its External Process has started, stopped or paused though a Start/Stop object (12). In the case of a process start the Start/Stop object handles the creation of the corresponding PAM and informs the WAP of its existence. In the case of a process stop, the Start/Stop object handles the release of related resources for the WAP.

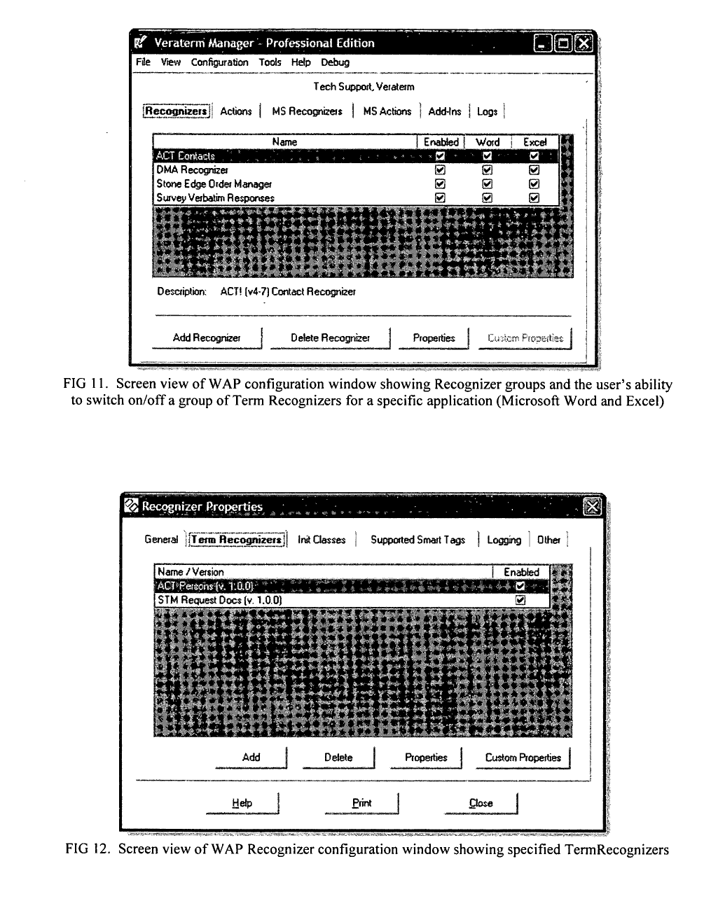

All PAMs contain an instance of a Term Recognizer Manager (TRM)(13) for the purpose of communicating directly with the Term Recognizers. The TRM loads operating parameters which specify how a specific PAM can interact with specific Term Recognizers (TRs). Behavior such as: whether a PAM can utilize a TR, whether a TR can be invoked when the user has the cursor positioned in the same cell, paragraph or sentence as the origin of the changed text and the number and type of TR passes, are examples of such behavior controls. The last two are integral to the operation of a specific PAM, but the first one is controllable by the user. FIG. 11 shows a screen view of the WAP configuration system showing how the user can manage the use of particular term recognizers by a particular application's PAM.

A PAM can instruct the TRM to propagate the results of the TR analyses through the WAP system, or it can invoke the Action Handler Manager (AHM)(FIG. 8, 14) itself. PAMs which are designed to invoke the Action Handler Manager contain a reference to the Action Handler Manager object or utilize the Event Subsystem to send messages to the AHM. PAMs interact with the TRM in a synchronous manner such that they can control the sequence of TR analyses and can perform additional operations after the TR analyses are completed, such as returning the results to the PC or invoking the Action Handler Manager directly. The Event Subsystem (15) can be utilized to handle communications between a PAM, the TRM and the AHM if loose coupling between those objects is indicated. Loose coupling is indicated when a PC and a PAM are created by a third party and incorporated into the WAP.

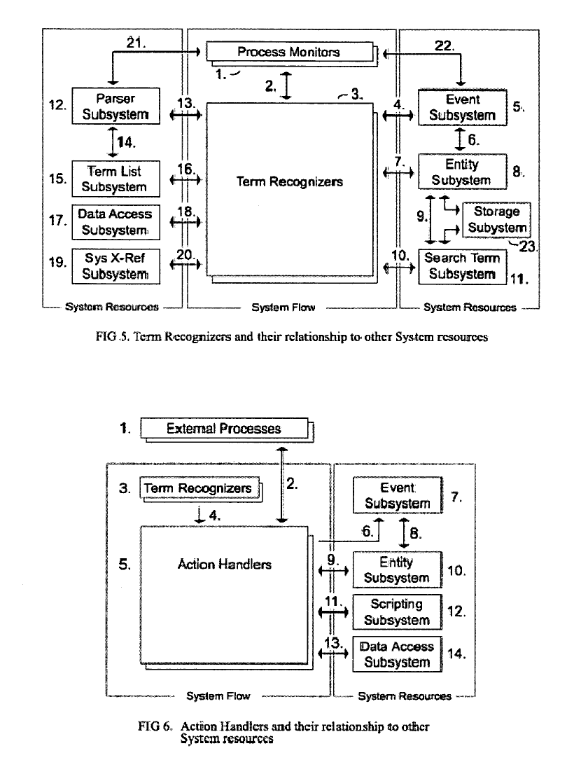

The system contains a plurality of term recognizers which perform analysis, relationship, and workflow-related functions, as shown in FIG. 5. They are the main functional units of the WAP. Term recognizers can respond to messages from process monitors(1) and from the event subsystem(5). Term recognizers have at their disposal other system resources such as the data access and data mapping subsystems. Term recognizers can query an external data system(17) for information to import or to form relationships with recognized terms. In addition, term recognizers can write or send messages to an external data system(17). For example, a term recognizer may be configured to respond to person names found within a text block. Such a term recognizer might also be configured to query a customer relations management (CRM) system for the presence or absence of a specific person name. Depending on what it finds, the term recognizer could be configured to respond differently for different scenarios.

Term recognizers propagate the system flow in a plurality of pathways. The main pathways are shown in FIG. 3. A message can be sent directly(9) to one or more action handlers(11), each of which performs specific functions; a notification can be sent(16) to an external system(10), which in turn initiates an action(l 7); a message can be sent to the event subsystem(7); data or a message can be sent to an external data system(8). These pathways are not exclusive of each other for a specific instance of system flow and the WAP system allows and supports customization of such pathways. In the example of the CRM system, a term recognizer may be configured to automatically send a message to an action handler which then logs an entry in the CRM database relating the current document to the CRM person record.

TRs are grouped logically, typically by application. These logical groups are called Recognizers and are declared in the WAP configuration window shown in FIG. 11. For a given Recognizer, one or more TRs can be specified as shown in FIG. 12. The WAP configuration window allows TRs to be enabled as a Recognizer group or individually. FIG. 9 depicts the objects that comprise the Term Recognizer Subsystem. The Term Recognizer Manager (1) instantiates and manages Recognizers (2). Each Recognizer instance delegates TR functionality to a Term Recognizer Container (3) which instantiates the designated TRs (4) and associates them with the designated Entity Atlas (11). An Entity Atlas is a metadata container and is shown in FIG. 7.

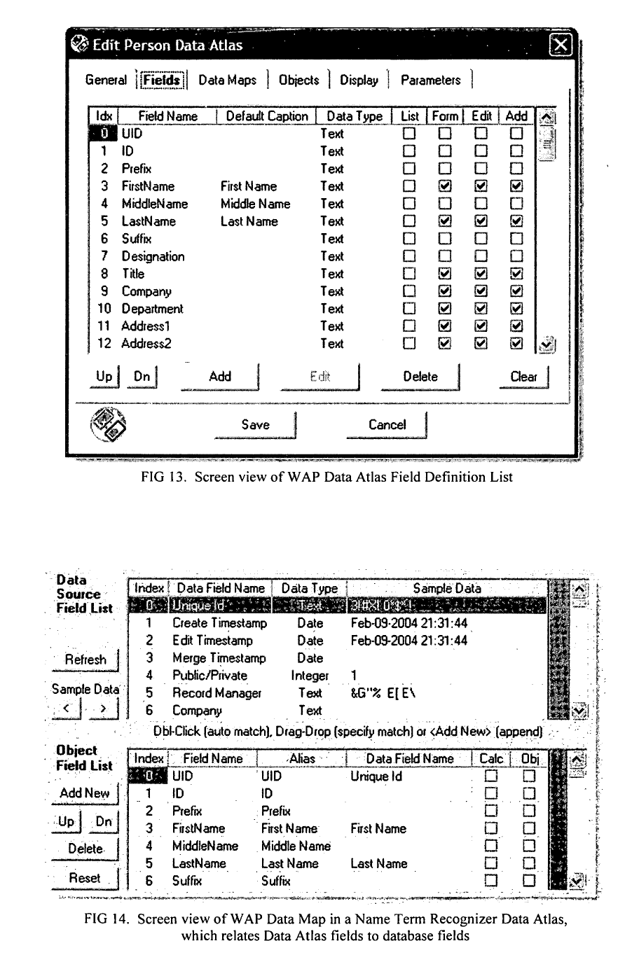

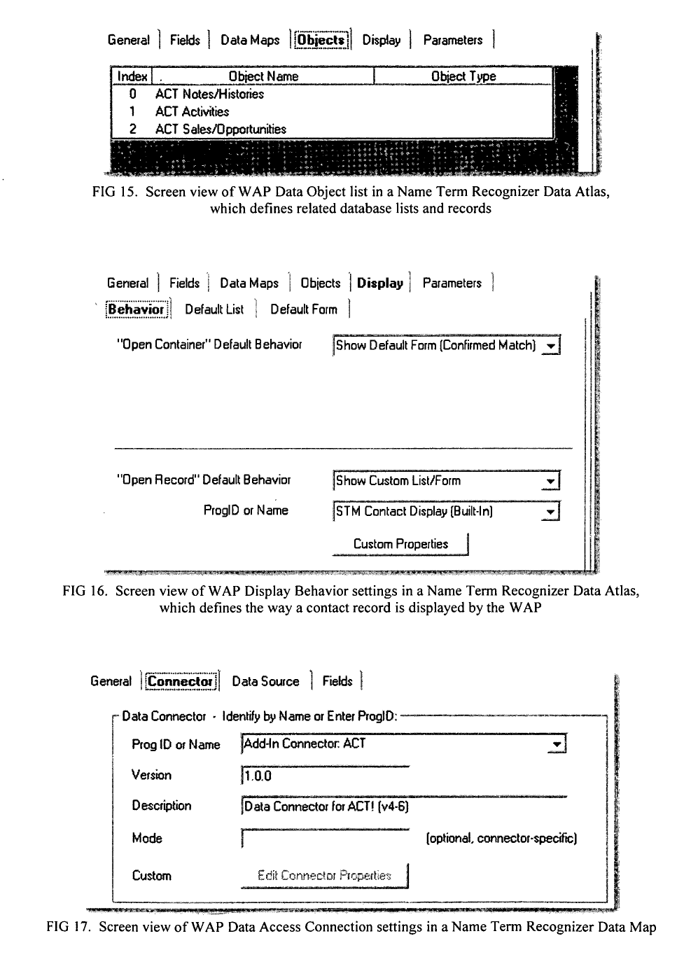

Entity Atlas content structure is specific to the type of TR with which it is associated. In the case of the Person Name Term Recognizer, the Entity Atlas describes the properties and data access details that are needed to relate a person name to a database record in an external database application. FIGS. 13-16 depict an implementation of the Name Term Recognizer's Data Atlas user interface, used to configure the WAP behavior to integrate with a contact management database application. FIG. 13 shows the field definition list for the WAP person entity object. The user is able to add custom fields and collections, such as a collection of invoices in an accounting system that is external to the contact management system; designate which fields are visible in a pick list or display form; and designate which fields are editable and insertable for new records. Captions can be specified where different from the actual field name. One or more Data Maps are related to a Data Atlas. A Data Map relates Data Atlas fields to the fields in a database as shown in FIG. 14. A Data Atlas is definable as a complex object containing other objects with specific links between the parent and child objects. A Data Atlas may contain one or more other objects, typically collections of records related to the parent as shown in FIG. 15. Each object in the object list has its own Data Atlas with its own Data Maps. Also in the Data Atlas specification are properties which instruct the WAP on how to display the entity when opened for viewing, editing or adding as a new record. FIG. 16 shows the configuration user interface that is used for the display settings. A Data Map also contains information which instructs the WAP system to use a Connector object in the Data Access Subsystem.

Term Recognizers perform analysis and relationship operations as controlled by Process Monitors and mediated by the Term recognizer Manager. The process begins with a submission of an instruction set to the TR, which contains the text to be analyzed. The Name TR is designed to identify person names, company names, job titles, addresses, phone numbers, email addresses and identifiers such as account numbers. Before looking up every word in a text block in a database, the TR uses the Preparser System to identify words and phrases which are in the form of those items. Preparsers are shared system resources and controlled by a Preparser Manager (FIG. 9, item 5.). The Preparser Manager ensures that the same block of text is not parsed multiple times for the same thing by multiple TRs. Preparers exist internally to the WAP that parse text blocks for items. In addition, the WAP supports externally created Preparsers through interfaces, such as COM, .NET, JAVA, XML interfaces and the like. Externally created Preparsers are also managed by the Preparser Manager.

As shown in FIG. 9 output from a TR is in the form of Context Term Objects (8) and Entity Objects (12). Context Terms are the primary output and are logical links between words and phases in a text block and information stored in the WAP, including analysis results such as Preparser findings and database lookup results. An external WAP client can look at the collection of Context Terms related to the specific document or text block to determine the analysis results. Entity Objects (12) are the output from the Data Access Subsystem and are containers of zero, one or more search results as per the instructions given to the Data Access Subsystem by the TR and as per the specified Entity Atlas which determines its content. The WAP can persist both Context Term and Entity Objects in the WAP Data Storage Subsystem and externally. A typical external location is in an XML document saved to a storage medium or embedded in a document from the External Process from which the analysis was performed. An Entity Object contains information which specifies its originating search criteria, one Entity Atlas and data loaded from one or more databases as determined by the Entity Atlas. Entity Objects contain information that enables the WAP to display the embedded information and control insert, update and delete operations according to the Data Atlas properties. Additionally, an Entity Object has the ability to display a pick-list when the user intends to perform an action on the Entity Object and the Entity Object contains multiple search results that cannot be resolved internally by the WAP. Entity Objects are also used by the Data Access Subsystem to buffer previous search results for a period of time specified by the TR instruction set. Buffering results can greatly reduce the number of times the WAP needs to access an external data source.

As shown in FIG. 9 the TR Subsystem contains a Cross Reference Manager (XRM)(9) which enables the WAP to relate Context Terms to each other for purposes of query refinement, inter-document aggregation of information and inter-data source aggregation of information. The XRM is used by the TR as directed by the TR's instruction set and/or information contained in the Entity Atlas. The XRM can look for related Context Terms in the WAP's persisted Context Term collection with constraints imposed by the instruction set. A simple example follows. An email is received from a person and the email content does not contain the person's name. A TR queries a database for the email address and is returned two records because two people share the email address. The Entity Container now contains these two records and no indication of a confirmed match. The XRM now finds a Context Term from an email sent within the last hour with a name that matches one of the two names in the current Entity Container. Because the XRM is instructed to do so, it marks the Entity Container as a match on one of the two records and instructs the Data Access Subsystem to fully load any remaining data for the confirmed match record as per instructions in the Entity Atlas. Typically the WAP would be configured to widen the search for cross-references across a wider range of document input sources and database systems. When the user opens the email the specified data set has already been loaded into the WAP Entity Container system and is available for immediate use as per further configuration instructions and possibly pending user instructions.

The XRM operates both synchronously and asynchronously in the WAP. A TR makes a synchronous call to the XRM in order to refine its search results and to make immediate comparisons to previous search results. Additionally, the XRM is part of an asynchronous process that is initiated by the Event Subsystem in response to related system events. Such events include the completion of a Data Access Subsystem search, the identification of a pattern in a text block by a preparser and the manual confirmation by a user from a user interface pick list. The Event Subsystem raises WAP system-wide events and § TR can respond as determined by its instruction set. A TR would typically respond by reexamining the Context Terms created by that TR through the functionality of the XRM.

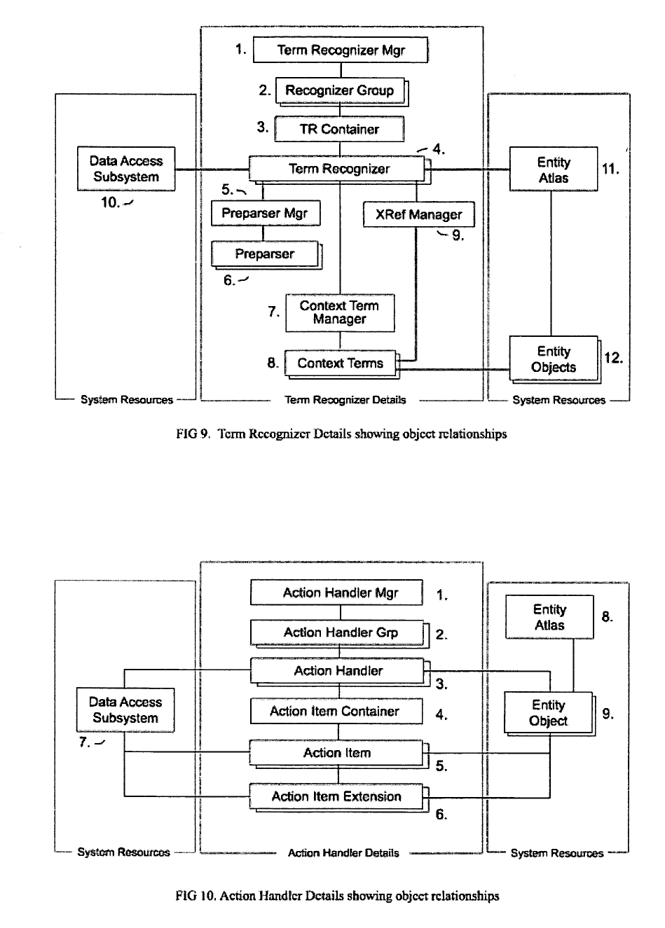

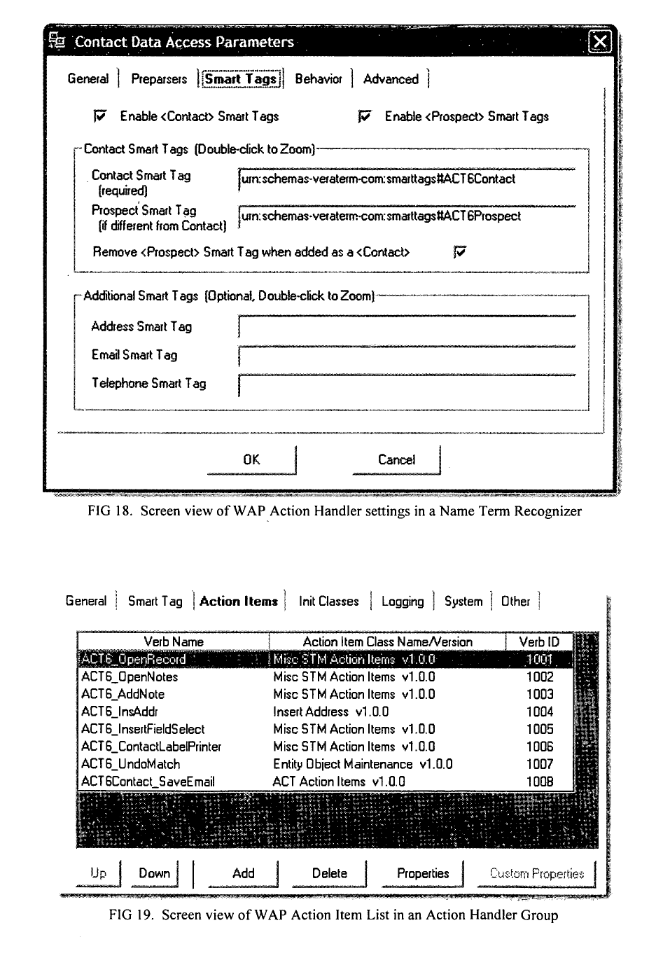

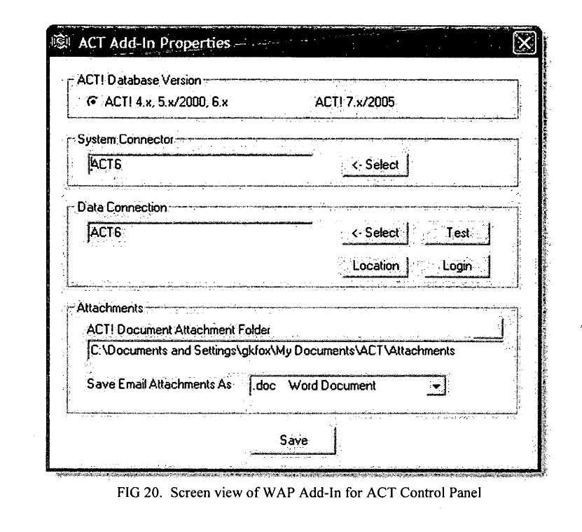

The Action Handler Subsystem executes one or more units of work representing endpoints of the workflow that is automated by the WAP. The WAP system contains methods of specifying, initiating and executing said units of work. FIG. 10 depicts the objects internal to the Action Handler Subsystem. The Action Handler Manager (1) accepts messages directly from other objects in the WAP and also subscribes to the Event Subsystem in order to respond to asynchronous system messages requesting that an action take place. The Action Handler Manager is the entry point to the Action Handler Subsystem. A TR can specify and initiate actions directly, which is typically utilized to create user interface elements for the user. As shown in FIG. 3, action handlers(11) can be invoked by one of several methods and an external system can invoke an action handler by way of a person who might interact with a user interface element(10, 17). FIG. 18 shows the configuration settings for a TR which directly creates a user interface element in a common desktop application.

Actions are divided into logical groups for convenience, such as for user interface displays. There can exist a plurality Action Handler Groups (2) and the groups may contain one or more Action Handlers (AH)(3). An AH can perform a function directly, execute a script which executes multiple functions and/or serve as a container for multiple Action Items (5) which execute specific functions. The AH hierarchy serves the purposes of code reuse and organizational flexibility. When a given AH will serve as a container for Action Items, it uses an Action Item Container object (4) which encapsulates the functionality required to manage multiple Action Items. Action Items may further use Action Item Extensions (6) to execute common tasks. Action Handlers, Action Items and Action Item Extensions can exist zero, one or more times in the hierarchical definition set of the Action Handler Subsystem.

Action Handlers and Action Items are uniquely addressable objects in the WAP system. Any other object or an external process can execute a WAP action by sending a message through the Event Subsystem. Actions may be void of any input parameters, instructions, or relationships, but typically actions are related to a Context Term. The Context Term is typically related to an Entity Object. A typical use of an Action Item, therefore, is to execute an action that involves an Entity Object, such as the automatic attachment of a document to a contact management notes list of a person referenced in that document. FIG. 19 shows a typical Action Item definition list in a single Action Handler Group. Such groups are defined logically; in this case for a persons name that was identified in a contact management database.

Action Handlers and Action Items may also be created externally and incorporated into the WAP system by external processes using WAP's interfaces, such as COM, .NET, XML, and JAVA interfaces. The Action Handler System can include Action Handlers and Action Items which are related to multiple Context Terms, multiple Entity Objects and multiple database systems.

As shown in FIG. 3, the Data Access Subsystem(15) handles all aspects of connectivity to and from external data systems. The data access subsystem manages one or more data access schemes, each of which may involve one or more data systems or programs. The schemes, systems, or programs may be independent of one another or there may be relationships between them. The data access system typically connects with both internal system metadata as well as with external systems. Term recognizers and action handlers are able to communicate with one or more data access components as needed and in a configurable manner.

PM's may be required to perform an analysis of the information obtained from the EP before propagating the WAP flow. Such analysis depends upon the nature of the EP and may include a comparison of current information with information previously obtained. To that end, an embodiment of the present system and method includes a document subsystem(6) with which a PM may communicate(7) as shown in FIG. 4. The document subsystem includes a storage mechanism which employs a document metaphor of document objects which contain a plurality document-section objects. The document subsystem provides a mechanism for the PM to persist state information concerning the EP which provides several benefits. Firstly, it provides a reusable storage mechanism for ongoing analysis. This benefit is exemplified in the case of a PM which is monitoring a word-processing process while a document is being edited. Assuming that the EP has no mechanism for informing the PM explicitly and in detail about the changes that are occurring, the PM must provide a mechanism for doing so in order to initiate a WAP. In this example the PM would periodically analyze and store the document content in the document subsystem and use the stored content as a basis for comparison at a later point in time. Secondly, document subsystem objects can be used as message containers as they are referenced and passed to subsequent steps in the system flow.

As shown in FIG. 4, the configuration(9) subsystem allows configuration and control over the WAP processes and the PM's in particular(8), including but not limited to filtering based on document size, document properties, and persistence state. The configuration subsystem is also used for specifying intervals of PM messages. In the case of a word-processor process the configuration subsystem is used to specify whether the PM propagates the system flow after document changes at the word level, sentence level, paragraph level, or document level.

As shown in FIG. 4, the logging subsystem(11) provides a configurable audit trail for the implementation of a WAP system. The importance of the logging subsystem to the overall process flow is elevated in the case of a PM monitoring a dynamic EP such as a word-processing application which is operating asynchronously while the PM is monitoring it. The logging system provides a mechanism for system administrators to monitor the WAP system by obtaining detailed feedback concerning the processes being monitored, enabling the user to adjust the WAP system via the configuration subsystem to achieve optimal performance.

FIG. 5 shows detailed relationships between term recognizers(TR)(3) and other system resources. The TR system is extensible. The WAP system provides a framework for including additional, for example newly developed, TR's in the WAP system. The configuration subsystem includes a mechanism for the inclusion of individual TR's.

The parser subsystem performs a plurality of analyses on a specified document. The WAP system is extensible and may incorporate additional analysis modules. A preparser is one such analysis module. A preparser is a process module that performs common analyses that are likely to be shared by multiple TR's. The inclusion of preparsers as system resources provides a significant benefit for WAP's which require multiple TR's by eliminating repetitive analyses. For example, preparsers may evaluate text blocks for phrases which resemble person names, telephone numbers, email addresses, job titles, and addresses. The results of preparser analyses are stored in the parent parser object for all TR's to consume. Preparsers are configurable and utilize the configuration subsystem for end-user control.

Another analysis performed by the parser subsystem on the specified document is a term list comparison. As shown in FIG. 5, the term list (TL) subsystem(15) contains a collection of configurable lists of information items or terms. The TL subsystem includes the configuration mechanism for declaration and specification of a term list which is persisted as system metadata. A TL may contain information acquired through a database query or from an external process. TL's may also contain information specified during the declaration or instantiation of the list or list object.

The TL subsystem contains a function which performs cross-match analyses between the document and the term list. TL's utilize a plurality of mechanisms to perform such analyses. The system is extensible, and may incorporate additional analysis modules. The purpose of the TL subsystem is the automation of complex comparisons, and to serve as a resource for configurable term recognizers. The parser object stores the results of such analyses for use by multiple TR's. The TL subsystem is flexible. The configuration of subsystem analysis behaviors such as single or multiple item matches per text block, single or multiple term matches per text block, case sensitivity control, alternate spelling specification, optional-word specification, item location specification and pattern matching is user specified. The TL subsystem includes two-way communication mechanisms allowing term recognizers to contribute to the configuration and intelligence of the TL subsystem by modifying term lists as indicated.

The process flow illustrated in FIG. 5 for the system is utilized in the embodiments of term recognizers. Other flows and resource uses are possible. The system resources may be used by any of the main functional subsystems, the subsystems which participate in the system flow. A TR configured to identify person names could use a name-preparser to identify name patterns in a body of text within a container. The name-preparser, in turn could use the term list subsystem to access metadata for the purpose of accomplishing its task. When a TR is returned a person name from the preparser, the TR can then use the search-term subsystem and the data access subsystem to relate that name to a data store. The system is then able to store or retrieve data related to the name as required by the WAP system.

As shown in FIG. 5, the search term subsystem(11) contains a search-term buffer which can be used to store previous search results. The search term subsystem increases speed and decreases network traffic by reducing the number of times the WAP system must access a data store outside the WAP system. A TR can query the search-term buffer(10) for recent search results and thereby possibly avoid repeating a recent external data store retrieval step. Similarly, when a TR performs a database query through the data access subsystem, it can publish(10) the results in the search-term buffer for subsequent use. The search-term subsystem uses the configuration subsystem to enable WAP system configuration. The operation of the search-term buffer can be configured to the level of specific item persistence properties and data persistence properties. The search-term subsystem makes use of the storage subsystem(23) for persistence of information beyond the computer power-up session, as shown in FIG. 5. The search-term subsystem includes mechanisms for purging expired data entries and for summarizing and reporting on system usage based on search-terms and their usage frequency.

As shown in FIG. 5, the entity subsystem(8) (ES) has the purpose of storing and managing virtual objects for the WAP system. The ES also uses the configuration subsystem and the data mapping subsystem. The entity container (EC) is the main object in the ES. The contained entities are described by metadata and are created by a plurality of consumers. The WAP system is extensible. The system is able to handle EC's from a plurality of sources. TR's use the ES(7) to store search result data and to provide an original source of data for analysis purposes. The search term subsystem uses the ES(9) to hold search result data. The ES can be configured at the level of specific data persistence properties. The ES makes use of the storage subsystem(23) for persistence of data beyond the computer power-up session. The ES includes mechanisms for purging expired data.

Term recognizers are able to perform complex analyses using multiple sources of information. A typical TR could look in a specified document for terms of interest by using the parser subsystem(12), as shown in FIG. 5. The TR could then relate each term of interest to external data sources through the data access subsystem(17) by using the search term subsystem(11). The TR could utilize the entity subsystem(8) to further refine the accuracy of data queries. The use of multiple information sources is of particular value in resolving conflicts in search result data.

As shown in FIG. 5, term recognizers can receive events from any publisher of events to the event subsystem(s). The event publishers of particular importance to TR's are external processes, the ES, and other TR's. TR's are able to reevaluate and refine their analyses after additional events have occurred. The ability to receive events from any publisher is important because it enables TR's to acquire information from a plurality of sources. The WAP system is extensible, and has the ability to add information sources to the TR environment.

A significant aspect of TR functionality is the ability to subscribe to events published by other TR's. The current system and method includes a feature, a two pass processing mechanism, which supports the ability to subscribe to events published by other TR's. A set of TR's which need to share information with each other or a TR which requires analysis results from another TR can implement this approach. Specifically, a TR can perform an initial analysis and publish an event intended for itself. By the time the TR responds to its' own event all other related TR's have performed their analyses. The WAP system supports this by requiring that all flow propagators include support for the two pass processing mechanism. The current system and method also includes a System Cross-Reference (XR) subsystem(19) to support information sharing between TR's. The XR subsystem defines specific points of information sharing in a configurable manner. A TR accesses(20) the XR subsystem when responding to events to determine whether or not to react or respond to that event.

FIG. 6 shows Action Handlers(5) (AH) and their relationship with other system resources. Action handlers receive messages from term recognizers(3) and from external processes(1). Messages(2) from external processes are typically in response to a user interface element as part of an automated workflow process that involves user confirmation or user-guided initiation. Messages(4) received from term recognizers are typically direct invocations of automated workflow resulting from the TR's analysis.

The WAP system comprises a plurality of action handlers. The system comprises a mechanism for incorporating AH's into the WAP system through the configuration subsystem. Within embodiments of the system and method an action handler is the process controller for one or more units of activity, or action items. An AH may directly perform a task or it may indirectly perform tasks through the scripting subsystem(12), as shown in FIG. 6. The scripting subsystem includes a specification language for executing one or more action items in combination with conditional logic, branching, and equation processing. The scripting engine itself is extensible in the present system.

An action handler is invoked with references to all related data pertaining to the workflow. The entity subsystem provides access to the entity containers related to the workflow. The entity subsystem provides the AH's with direct access to data on which the AH's must operate. The action handler subsystem contains a mechanism for performing common operations on entity containers, such as choosing from a list and editing content. Activities performed on entity containers result in new system events(8) which in turn result in term recognizer event responses.

As shown in FIG. 6, the data access subsystem(14) can be accessed(13) by AH's for many purposes. AH tasks might include, but are not limited to, document content insertion, document creation, data insertion/updating/deleting, email creation, email transmission, and application user interface access. External processes(1) are common initiators of AH's and are often affected(2) by AH workflow output.

The system flow depicted in FIG. 3 begins with a process monitor and ends with an action handler. System resources exist to make the system flow possible, configurable, efficient and productive. A significant benefit of the present system is the inclusion of process flow components and supporting system resources in one system. The Data Mapping Subsystem (DMS) is one such resourse.

FIG. 7 shows the Data Mapping Subsystem objects and their relationship to main system resources. An Entity Atlas(1) comprises metadata which describes an entity object. An entity declaration contains properties, data maps, data links and sub-entities. An entity declaration also contains metadata pertaining to display, edit ability and security.

As shown in FIG. 7, Data Maps(2) describe a particular data operation, such as browse, load, insert, update or delete, relating the data source to the entity atlas. They describe data access parameters such as connections, tables, and sorting. They describe field mapping and include declarations of field operations. Data Maps are used to specify system relationships with data sources of varying types, such as SQL data sources, text data sources, binary data sources, and custom application programmer interfaces (API's).

An entity property may be a standard property value or an entity property may be defined as another entity object, such as a collection of invoices for a customer. In such cases the invoice entity itself is described in another Entity Atlas. The Data Map uses a Data Link(3) object to relate the parent object to child objects, as shown in FIG. 7. The data link specifies operations and linking properties between the two objects. Parent and child objects can be related to separate data sources. Each retains metadata pertaining to its own persistence mechanism. The data linking feature offers the benefit to the system of supporting integration between disparate data sources in an efficient and configurable manner. The Data Mapping subsystem contains a Data Container(4) specification. The Data Container serves as a vessel containing information as the information is transferred between data sources and entity containers.

In addition to the system resources depicted in the Drawings, the present system also contains subsystems which handle security, database connections, resource pooling, and logins.

The system provides a workflow automation system comprising process monitors, term recognizers and action handlers and typically operates by performing the following steps:
(a) monitoring an external process with at least one process monitor;
(b) communicating data from an external process to at least one term recognizer;
(c) the term recognizer analyzing the data for terms;
(d) the term recognizer retrieving data related to terms from a data access component;
(e) the term recognizer assembling retrieved data for presentation to a user;
(f) the term recognizer communicating assembled data to at least one action handler;
(g) at least one action handler taking an action with the assembled data.

The process monitors may be configured to monitor telephone monitoring systems, word processing systems, electronic mail systems, spreadsheet systems, and other application programs. The action handlers may display information to users, create electronic mail messages, create documents, add information to a document, or perform other actions with the retrieved and assembled data.

An example of the operation of the system and method is as follows. A customer service representative receives an email request for information or product samples. The workflow involves the following activities:
(a) identifying the person who sent the email by name, account number, or email address;
(b) searching for the person in a company database;
(c) determining if a record of the person exists in the database by comparing personal information (name, address, telephone numbers, email addresses) contained in the email with the corresponding personal information stored in the database;
(d) optionally updating the database information;
(e) optionally adding the person to the database (if they are not already present);
(f) examining the request;
(g) fulfilling the request. (For example with a reply email containing the desired content or with an entry to an order processing system for brochures or samples.)

Another example of the use of the system involves a user responding to a client on the telephone. The workflow involves the following activities:
(a) receiving a telephone call from a person;
(a) receiving the caller id from an external process;
(b) searching for the person in a company database;
(c) determining if a record of the person exists in the database by comparing the caller id with caller id records in the corresponding database;
(d) displaying caller information to user;
(e) optionally updating the database information (for example date of call, time of call, duration of call, person history);
(f) optionally accepting user information related to the caller and reason for the call;
(g) fulfilling the request. (For example with a reply email containing the desired content or with an entry to an order processing system for brochures or samples.)

The present system and method automates the steps described. In the case of a reply email, a response would sent automatically or optionally be placed in an email outbox for review. In addition, the present system and method makes customer information (personal details, invoices, purchase orders) available automatically so that the customer service representative may easily view customer-related information without further searching.

It is understood that the specific embodiments of the system and method that have been described are merely illustrative of applications of the present system and method. Modifications may be made to the workflow automation processor system and associated methods described herein without deviating from the spirit and scope of the present system and method. Moreover, while the present system and method is described for illustration purposes only in relation to human business workflow, it should be clear that the system and method are applicable to the automation of other computer-related processes.

As used herein, a ‘transaction’ is intended to mean any unit of work that involves movement of computer information.

As used herein, ‘workflow’ is the term used to describe the composite sum of human effort related to the processing of one or more transactions.

As used herein, the term ‘document’ is used in its broadest scope, meaning a container of information. Thus, a document could refer to an electronic-paper document, information stored in computer memory, or any other container of information.

As used herein, ‘orchestrate’ or ‘orchestrating’ refers to managing or coordinating, such as managing or coordinating computer processes, managing human/computer interactions and processes, managing or coordinating a response to customer, or managing or coordinating data within a computer.

As used herein, ‘container’ refers to a temporary or permanent storage mechanism for electronic data, for example temporary or permanent computer memory such as RAM, magnetic disk, magnetic tape, CDROM, or CDRW.

As used herein, ‘publish’ and ‘subscribe’ refers to a mechanism whereby a provider of information, the publisher, notifies one or more recipients, the subscribers, of the availability of information.

Typically the information used in a publish and subscribe system is in electronic format. The use of the term publish and subscribe is well known to those of ordinary skill in the art.

As used herein, ‘system flow’ refers to the flow of information and events through the system. In response to an initiating event, information and events flow through the system, optionally involving the user, until output is generated.

As used herein, ‘data access scheme’ refers to the data contained within a data storage system, such as a database, and the way the data are organized for storage and retrieval.

As used herein, ‘metadata’ is data that describe other data. For example, raw data may be stored in a database. For ease of storage and retrieval the data may be organized into columns, rows, and tables. Data describing the columns, row, and tables is metadata. Metadata comprises a structured set of descriptive elements that describe an information resource, or more generally any definable entity.

As used herein, ‘instantiate’ or ‘instantiated’ refers to the creation of a particular software object based upon a general class definition. The terms instantiate, object, and class are well known to those of ordinary skill in the art.

As used herein, ‘hook’ or ‘add-in’ refers to a way to communicate with another system or program, such as through the system or program's application programming interface.

As used herein, ‘propagate’ or ‘propagates’ refers to sending messages and/or data to other processes involved in the system flow.

As used herein, ‘persist’ or ‘persistence’ refers to storing information, such as storing data in temporary or permanent computer memory. To persist state is to store an information snapshot describing the condition of a process or program at a given moment. Persist and state are terms which are well known to those of ordinary skill in the art.

As used herein, a ‘data store’ refers to a place where information is stored permanently, such as a database, or a table, or a computer file.

As used herein, a ‘virtual object’ refers to a computer representation of an entity. Virtual object and entity are terms which are well known to those of ordinary skill in the art.

As used herein, ‘computer power-up session’ refers to an interval of time during which the computer is on and functioning. A session ends upon computer shutdown and turning off the power.

As used herein, ‘flow propagators’ are processes in the main system pathway which send messages and/or data to subsequent processes in the system pathway.

As used herein, ‘units of activity’ refers to the smallest definable portion of a task.

As used herein, ‘external process’ refers to a computer process not running under the control of the workflow automation process system. Typically an external process is a program such as a word processing program, an electronic mail program, a database management program, a telephone monitoring program, or other program.

What is claimed is:

1. A system for workflow automation, the system comprising:
at least one user interface component for displaying information to users and receiving input from users;
at least one processor monitor;
wherein the at least one process monitor monitors at least one external process;
wherein the at least one process monitor communicates data to at least one term recognizer;
at least one term recognizer;
wherein the at least one term recognizer analyzes data for terms;
wherein the at least one term recognizer retrieves data related to terms from at least one data access component;
wherein the at least one term recognizer assembles data related to terms;
wherein the at least one term recognizer communicates data to other system components;
at least one action handler;
wherein the at least one action handler receives assembled data from at least one term recognizer;
wherein the at least one action handler initiate at least one action;

2. The system of claim 1 wherein at least one process monitor is configured to monitor a telephone system.

3. The system of claim 1 wherein at least one process monitor is configured to monitor a word processing system.

4. The system of claim 1 wherein at least one process monitor is configured to monitor an electronic mail system.

5. The system of claim 1 wherein the system is configured to display data to a user for a decision.

6. The system of claim 1 further comprising system configuration components.

7. The system of claim 1 further comprising at least one application programming interface.

8. A method of automating workflow comprising the steps of:
(a) providing a workflow automation system comprising at least one process monitor, at least one term recognizer, and at least one action handler;
(b) monitoring at least one external process with at least one process monitor;
(c) communicating data from an external process to at least one term recognizer;
(d) the at least one term recognizer analyzing the data for terms;
(e) the at least one term recognizer retrieving data related to terms from a data access component;
(f) the at least one term recognizer assembling retrieved data for presentation to a user;
(g) the at least one term recognizer communicating assembled data to at least one action handler;
(h) at least one action handler taking an action with the assembled data.

9. The method of claim 8 wherein the action comprises displaying information to a user.

10. The method of claim 8 wherein the action comprises creating at least one electronic mail message.

11. The method of claim 8 wherein the external process is an electronic mail system.

12. The method of claim 8 wherein the external process is a telephone monitoring system.

13. The method of claim 8 wherein the external process is a word processing system.

14. A computer readable medium comprising a system for workflow automation, the system comprising:
at least one user interface component for displaying information to users and receiving input from users;
at least one processor monitor;
wherein the at least one process monitor monitors at least one external process;
wherein the at least one process monitor communicates data to at least one term recognizer;
at least one term recognizer;
wherein the at least one term recognizer analyzes data for terms;
wherein the at least one term recognizer retrieves data related to terms from at least one data access component;
wherein the at least one term recognizer assembles data related to terms;
wherein the at least one term recognizer communicates data to other system components; at least one action handler;
wherein the at least one action handler receives assembled data from at least one term recognizer;
wherein the at least one action handler initiates an action.

15. The computer readable medium of claim 14 wherein at least one process monitor is configured to monitor a telephone system.

16. The computer readable medium of claim 14 wherein at least one process monitor is configured to monitor a word processing system.

17. The computer readable medium of claim 14 wherein at least one process monitor is configured to monitor an electronic mail system.

18. The computer readable medium of claim 14 wherein the system is configured to display data to a user for decision.

19. The computer readable medium of claim 14 wherein the system further comprises system configuration components.

20. The computer readable medium of claim 14 wherein the system further comprises at least one application programming interface.
